(19) United States
(12) Patent Application Publication
(10) Pub. No.: US 2025/0361338 A1
(43) Pub. Date: Nov. 27, 2025

(54) PROCESS FOR THE SYNTHESIS OF POLYETHYLENES OR COPOLYMERS OF ETHYLENE AND 1,3-DIENE HAVING A TERMINAL KETONE FUNCTION

(71) Applicants: Compagnie Generale Des Etablissements Michelin, Clermont-Ferrand (FR); CENTRE NATIONAL DE LA RECHERCHE SCIENTIFIQUE, PARIS CEDEX 16 (FR); ECOLE SUPÉRIEURE DE CHIMIE PHYSIQUE ELECTRONIQUE DE LYON, VILLEURBANNE CEDEX (FR); UNIVERSITÉ CLAUDE BERNARD LYON 1, VILLEURBANNE CEDEX (FR)

(72) Inventors: Christophe BOISSON, Clermont-Ferrand (FR); Franck D'AGOSTO, Clermont-Ferrand (FR); Ariane DESGRANGES, Clermont-Ferrand (FR); Robert NGO, Clermont-Ferrand (FR); François JEAN-BAPTISTE-DIT-DOMINIQUE, Clermont-Ferrand (FR)

(21) Appl. No.: 18/872,054

(22) PCT Filed: May 30, 2023
(86) PCT No.: PCT/EP2023/064414

§ 371 Date: Dec. 5, 2024

(30) Foreign Application Priority Data
Jun. 9, 2022 (FR) FR2205549

(51) Int. Cl. C08F 10/02; C08F 36/06

(52) U.S. Cl. CPC C08F 10/02; C08F 36/06

(57) ABSTRACT

A process for preparing a polyethylene bearing a terminal ketone function or a copolymer of ethylene and a 1,3-diene and optionally a vinylaromatic compound which contains more than 50 mol % of ethylene and bears a terminal ketone function is provided. The process comprises a polymerization reaction of the monomers in the presence of a borohydrido-neodymocene complex and an organomagnesium reagent, followed by a coupling reaction with a compound containing a nitrile function, and then a hydrolysis reaction.

### CROSS REFERENCE TO RELATED APPLICATIONS

This U.S. patent application is a national phase entry of PCT Patent Application No. PCT/EP2023/064414, filed May 30, 2023, which claims priority to French Patent Application No. FR 2205549, filed Jun. 9, 2022, the entire contents of which are incorporated herein by reference in their entirety.

### BACKGROUND

### 1. Technical Field

The field of the invention is that of polyethylenes and copolymers of ethylene and α-olefins which are rich in ethylene units and which are functionalized at the chain end with a polar function, a ketone.

### 2. Related Art

The synthesis of polyethylenes and α-olefin copolymers is widely described in the scientific literature. It is well known that the choice of polymerization route will determine the structure of the polymer chain. Polymerization by means of coordination catalysis using certain neodymium-based metallocenes may lead to the production of polyethylenes and diene copolymers which are rich in ethylene units, containing more than 50 mol % of ethylene units, as described, for example, in WO 2014/114607 A1. In particular, copolymers containing ethylene units and diene units are synthesized by a polymerization mechanism involving highly specific reactive species and numerous transfer reactions as described, for example, in ACS Catalysis, 2016, Volume 6, Issue 2, pages 1028-1036.

Highly saturated polymers such as polyethylenes and diene copolymers rich in ethylene units are essentially hydrocarbon-based and have little affinity for polar materials, which has the consequence of restricting the field of application of these highly saturated hydrocarbon-based polymers. In order to improve this affinity, the introduction of one or more ketone functions has been described in the case of polyethylenes. For example, the synthesis of copolymers of ethylene and carbon monoxide is widely described, but the synthetic process does not apply to copolymers of ethylene and an α-olefin such as a 1,3-diene or a mixture of a 1,3-diene and a vinylaromatic compound. Moreover, the synthetic process does not selectively lead to the introduction of a chain-end ketone function. The introduction of a single ketone function at the chain end of a polyethylene is also described. For example, Polymer Science, Ser. B, Vol. 46, Nos. 9-10, 2004, 308-311 describes the reaction between nitrous oxide and a polyethylene bearing a vinyl group at the chain end. The introduction of the ketone function at the chain end of the polyethylene results from the oxidation reaction of the double bond of the vinyl group with nitrous oxide. Consequently, it is seen that the synthetic process is not applicable to the chain-end selective functionalization of copolymers of ethylene and a 1,3-diene which contain double bonds also outside the chain ends.

Finally, the processes described for introducing ketone functions also do not allow a second function other than a ketone function to be introduced simultaneously with the ketone function. To do this, they must resort to the use of an additional functionalizing agent.

### SUMMARY

The Applicants have developed a process which allows a ketone function to be introduced at the chain end of a polymer, and which is applicable both to polyethylenes and to diene copolymers which are rich in ethylene units, such as copolymers of ethylene and a 1,3-diene or even a copolymer of ethylene, a 1,3-diene and a vinylaromatic compound. Moreover, the process is suitable for introducing two functions simultaneously, a ketone function and a second function other than a ketone function, without having to resort to an additional functionalizing agent.

A first subject of the invention is a process for preparing a polymer containing more than 50 mol % of ethylene units and bearing a ketone function at one of its chain ends, which process comprises the successive steps a), b) and c)
step a) being the polymerization of an ethylene-containing monomer mixture in the presence of a catalytic system based on at least one metallocene of formula (I) and an organomagnesium reagent

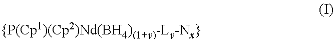

Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom, Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
step b) being the reaction of a compound containing a nitrile function with the product of the polymerization reaction of step a),
step c) being a hydrolysis reaction,
the polymer being a polyethylene or a copolymer of ethylene and a 1,3-diene and optionally a vinylaromatic compound.

A second subject of the invention is a polymer containing more than 50 mol % of ethylene units and bearing at one of its chain ends a ketone function and optionally a second function which is borne on the same chain end as the ketone function and which is chosen from ether, thioether, amine, alkoxysilane, silanol and imidazole functions, which polymer is a copolymer of ethylene and a 1,3-diene or a copolymer of ethylene, a 1,3-diene and a vinylaromatic compound and may be obtained via particular embodiments of the process in accordance with the invention.

A third subject of the invention is a polyethylene bearing at one of its chain ends a ketone function and a second function which is borne on the same chain end as the ketone function and which is chosen from ether, thioether, amine, alkoxysilane, silanol and imidazole functions, which polyethylene may be obtained via particular embodiments of the process in accordance with the invention.

### DETAILED DESCRIPTION OF EXAMPLE EMBODIMENTS

Any interval of values denoted by the expression “between a and b” represents the range of values greater than “a” and less than “b” (that is to say limits a and b excluded), whereas any interval of values denoted by the expression “from a to b” means the range of values extending from “a” up to “b” (that is to say including the strict limits a and b).

Unless otherwise indicated, the contents of the units resulting from the insertion of a monomer into a polymer are expressed as molar percentage relative to all of the units resulting from the polymerization of the monomers.

The compounds mentioned in the description may be of fossil origin or may be biobased. In the latter case, they may be partially or totally derived from biomass or may be obtained from renewable starting materials derived from biomass. Similarly, the compounds mentioned may also originate from the recycling of already-used materials, i.e. they may partially or totally result from a recycling process, or else be obtained from starting materials which themselves result from a recycling process.

The term “based on” used to define the constituents of the catalytic system means the mixture of these constituents, or the product of the reaction of a portion or all of these constituents with each other.

Step a) of the process in accordance with the invention is a polymerization reaction of an ethylene-containing monomer mixture which allows the preparation of polymer chains, growing chains intended to react in the following step, step b), with a functionalizing agent, a compound containing a nitrile function.

According to a first alternative, the ethylene-containing monomer mixture is ethylene, i.e. a monomer mixture consisting solely of ethylene. According to this alternative, the product of the polymerization reaction of step a) is a polymer chain whose constituent units result from the insertion of ethylene. The polymer prepared via this alternative is an ethylene homopolymer, a polyethylene.

According to a second alternative, the ethylene-containing monomer mixture is a mixture of ethylene and a 1,3-diene. According to this alternative, the reaction product of the polymerization of step a) is a polymer chain whose constituent units result from the insertion of ethylene and 1,3-diene. The polymer prepared via this second alternative is a copolymer of ethylene and a 1,3-diene.

According to a third alternative of the invention, the ethylene-containing monomer mixture is a mixture of ethylene, a 1,3-diene and a vinylaromatic compound. According to this alternative, the reaction product of the polymerization of step a) is a polymer chain whose constituent units result from the insertion of ethylene, 1,3-diene and the vinylaromatic compound. The polymer prepared via this third alternative is a copolymer of ethylene, a 1,3-diene and a vinylaromatic compound.

The 1,3-diene of the monomer mixture of step a) that is useful for the purposes of the second alternative and the third alternative is a single compound, i.e. a single 1,3-diene, or is a mixture of 1,3-dienes which differ from each other in chemical structure. 1,3-dienes that are suitable for use are 1,3-dienes containing from 4 to 20 carbon atoms, such as 1,3-butadiene, isoprene, myrcene and β-farnesene, and mixtures thereof. The 1,3-diene is preferably 1,3-butadiene, isoprene, myrcene, β-farnesene or mixtures thereof, in particular a mixture of at least two of them.

The vinylaromatic compound of the monomer mixture of step a) that is useful for the purposes of the third alternative is a single compound, i.e. a single vinylaromatic compound, or is a mixture of vinylaromatic compounds which differ from each other in chemical structure. The term “vinylaromatic compound” means an aromatic compound substituted with a vinyl function of well-known formula (—CH═CH₂). Most particularly suitable as vinylaromatic compounds are those containing an aryl group substituted with a vinyl function, and more particularly those containing a phenyl group substituted with a vinyl function. The vinylaromatic compound is preferentially styrene or a styrene the benzene ring of which is substituted with alkyl groups. The vinylaromatic compound is more preferentially styrene. The copolymer prepared via a preferential embodiment of the third alternative is a copolymer of ethylene, a 1,3-diene and styrene.

Preferably, the monomer mixture of step a) contains more than 50 mol % of ethylene, the percentage being expressed relative to the total number of moles of monomer in the monomer mixture of step a). When the monomer mixture contains a vinylaromatic compound, such as styrene, it preferentially contains less than 40 mol % of the vinylaromatic compound, the percentage being expressed relative to the total number of moles of monomers in the monomer mixture of step a).

Polymerization of the monomer mixture may be performed in accordance with patent applications WO 2007/054223 A2 and WO 2007/054224 A2 using a catalytic system (or catalytic composition) composed of a metallocene and an organomagnesium reagent.

In the present patent application, the term “metallocene” means an organometallic complex, the metal of which, in the case in point the neodymium atom, is bonded to a molecule named a ligand and consisting of two groups Cp¹ and Cp² connected together by a bridge P. These groups Cp¹ and Cp², which are identical or different, are chosen from the group consisting of fluorenyl groups, cyclopentadienyl groups and indenyl groups, these groups possibly being substituted or unsubstituted.

According to the invention, the metallocene used as base constituent in the catalytic system corresponds to formula (Ia)

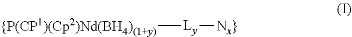

P being a group bridging the two groups Cp¹ and Cp² and comprising a silicon or carbon atom,
Cp¹ and Cp², which are identical or different, being chosen from the group consisting of fluorenyl groups, cyclopentadienyl groups and indenyl groups, the groups being substituted or unsubstituted,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,

In formula (I), the neodymium atom is connected to a ligand molecule consisting of the two groups Cp¹ and Cp² which are connected together by a bridge P. Preferably, the symbol P, denoted by the term bridge, corresponds to the formula ZR¹R², Z representing a silicon or carbon atom, R¹ and R², which are identical or different, representing an alkyl group comprising from 1 to 20 carbon atoms. More preferentially, the bridge P is of formula SiR¹R², R¹ and R² being identical and as defined previously. More preferentially still, P corresponds to the formula SiMe₂.

In formula (I), any ether which has the ability to complex the alkali metal, notably diethyl ether, methyltetrahydrofuran and tetrahydrofuran, preferentially tetrahydrofuran, is suitable as ether.

As substituted cyclopentadienyl, fluorenyl and indenyl groups, mention may be made of those substituted with alkyl groups containing from 1 to 6 carbon atoms or with aryl groups containing from 6 to 12 carbon atoms or else with trialkylsilyl groups, such as SiMe₃. When the ligands Cp¹ and Cp² are substituted, they are preferentially substituted with methyl groups, with butyl groups, notably tert-butyl groups, or with trimethylsilyl groups. The choice of the groups is also guided by the accessibility to the corresponding molecules, which are the substituted cyclopentadienes, fluorenes and indenes, since said molecules are commercially available or can be readily synthesized.

As substituted fluorenyl groups, mention may be made of those substituted in position 2, 7, 3 or 6, particularly 2,7-di(tert-butyl)fluorenyl and 3,6-di(tert-butyl)fluorenyl. The 2, 3, 6 and 7 positions respectively denote the position of the carbon atoms of the rings as represented in the diagram below, the 9 position corresponding to the carbon atom to which the bridge P is attached.

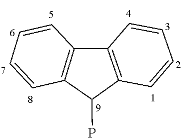

As substituted cyclopentadienyl groups, mention may be made of those substituted either in the 2 (or 5) position or in the 3 (or 4) position, particularly those substituted in the 2 position, more particularly the tetramethylcyclopentadienyl group. Position 2 (or 5) denotes the position of the carbon atom which is adjacent to the carbon atom to which the bridge P is attached, as is represented in the diagram below. As a reminder, substitution in position 2 or 5 is also referred to as substitution in the a position relative to the bridge.

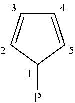

As substituted indenyl groups, mention may be made particularly of those substituted in the 2 position, more particularly 2-methylindenyl or 2-phenylindenyl. Position 2 denotes the position of the carbon atom which is adjacent to the carbon atom to which the bridge P is attached, as is represented in the diagram below.

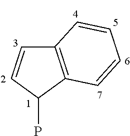

Preferably, Cp¹ and Cp², which are identical or different, are cyclopentadienyls substituted in the alpha position relative to the bridge, substituted fluorenyls, substituted indenyls or fluorenyls of formula C₁₃H₈ or indenyls of formula C₉H₆. More preferentially, Cp¹ and Cp², which are identical or different, are substituted fluorenyl groups or unsubstituted fluorenyl groups of formula C₁₃H₈. Advantageously, Cp¹ and Cp² are unsubstituted fluorenyl groups of formula C₁₃H₈, represented by the symbol Flu.

Better still, the metallocene is of formula (I-1), (I-2), (I-3), (I-4) or (I-5):

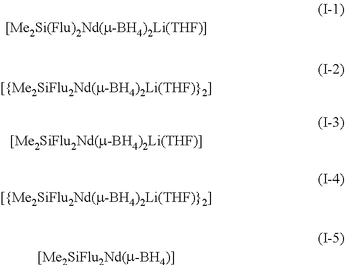

in which Flu represents the C₁₃H₈ group.

The metallocene that is useful for the synthesis of the catalytic system may be in the form of a crystalline or non-crystalline powder, or else in the form of single crystals. The metallocene may be in a monomer or dimer form, these forms depending on the method of preparation of the metallocene, as is described, for example, in patent application WO 2007/054224 A2 or WO 2007/054223 A2. The metallocene may be prepared conventionally by a process analogous to that described in patent application WO 2007/054224 A2 or WO 2007/054223 A2, notably by reaction, under inert and anhydrous conditions, of the salt of an alkali metal of the ligand with a borohydride of the rare-earth metal neodymium, in a suitable solvent, such as an ether, for instance diethyl ether or tetrahydrofuran, or any other solvent known to those skilled in the art. After reaction, the metallocene is separated from the reaction by-products via techniques known to those skilled in the art, such as filtration or precipitation from a second solvent. The metallocene is finally dried and isolated in solid form.

The organomagnesium reagent, another basic constituent of the catalytic system, is the co-catalyst of the catalytic system. Typically, the organomagnesium reagent may be a diorganomagnesium reagent or an organomagnesium halide. The organomagnesium reagent may be of formula (IIa), (IIb), (IIc) or (IId) in which R³, R⁴, R⁵ and R^{B}, which are identical or different, represent a carbon-based group, R^{A} represents a divalent carbon-based group, X is a halogen atom, and m is a number greater than or equal to 1, preferably equal to 1.

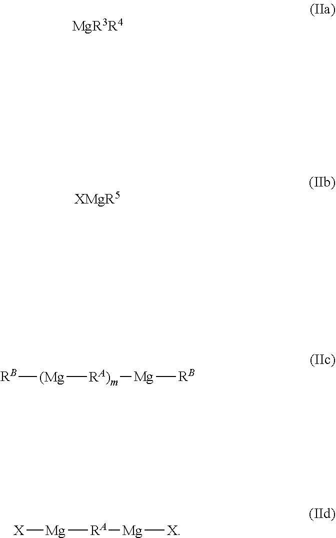

R^{A} may be a divalent aliphatic hydrocarbon-based chain, optionally interrupted with one or more oxygen or sulfur atoms or with one or more arylene groups.

The term “carbon-based group” means a group which contains one or more carbon atoms. The carbon-based group may be a hydrocarbon-based group (hydrocarbyl group) or a heterohydrocarbon-based group, i.e. a group including one or more heteroatoms in addition to carbon and hydrogen atoms. As organomagnesium reagents containing a heterohydrocarbon group, the compounds described as transfer agents in patent application WO 2016/092227 A1 may be suitable for use. The carbon-based groups represented by the symbols R³, R⁴, R⁵, R^{B} and R^{A} are preferentially hydrocarbon-based groups.

Preferably, R^{A} contains 3 to 10 carbon atoms, in particular 3 to 8 carbon atoms.

Preferably, R^{A} is a divalent hydrocarbon-based chain. Preferably, R^{A} is a branched or linear alkanediyl, a cycloalkanediyl or a xylenediyl radical. More preferentially, R^{A} is an alkanediyl. Even more preferentially, R^{A} is an alkanediyl containing 3 to 10 carbon atoms. Advantageously, R^{A} is an alkanediyl containing 3 to 8 carbon atoms. Very advantageously, R^{A} is a linear alkanediyl. 1,3-propanediyl, 1,4-butanediyl, 1,5-pentanediyl, 1,6-hexanediyl, 1,7-heptanediyl and 1,8-octanediyl are most particularly suitable as group R^{A}.

The carbon-based groups represented by R³, R⁴, R⁵ and R^{B}, may be aliphatic or aromatic. They may contain one or more heteroatoms such as an oxygen, nitrogen, silicon or sulfur atom. Preferably, they are alkyl, phenyl or aryl. They may contain from 1 to 20 carbon atoms.

The alkyls represented R³, R⁴, R⁵ and R^{B} may contain 2 to 10 carbon atoms and are notably ethyl, butyl, octyl.

The aryls represented R³, R⁴, R⁵ and R^{B} may contain 7 to 20 carbon atoms and are notably phenyl substituted with one or more alkyls such as methyl, ethyl, isopropyl.

According to a particular embodiment of the invention, R³ comprises a benzene nucleus substituted with a magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl and R⁴ is an alkyl. In other words, said mentioned methyl, ethyl and isopropyl substituents of the benzene ring are in the ortho position relative to the magnesium atom according to this particular embodiment. R³ may be 1,3-dimethylphenyl, 1,3-diethylphenyl, mesityl, or 1,3,5-triethylphenyl and R⁴ may be ethyl, butyl or octyl.

According to a particular embodiment of the invention, R³ and R⁴ are alkyls containing 2 to 10 carbon atoms, notably ethyl, butyl or octyl.

R⁵ is preferentially an alkyl containing 2 to 10 carbon atoms, more preferably ethyl, propyl, butyl, pentyl, hexyl, heptyl or octyl.

R^{B} may comprise a benzene nucleus substituted with a magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl. R^{B} may be 1,3-dimethylphenyl, 1,3-diethylphenyl, mesityl, or 1,3,5-triethylphenyl.

For example, suitable organomagnesium reagents are butylethylmagnesium, butyloctylmagnesium, ethylmagnesium chloride, butylmagnesium chloride, pentylmagnesium chloride, ethylmagnesium bromide, butylmagnesium bromide, pentylmagnesium bromide, octylmagnesium chloride, octylmagnesium bromide, 2,6-dimethylphenylbutylmagnesium, 2,6-diethylphenylethylmagnesium, butyl-2-mesitylmagnesium, ethyl-2-mesitylmagnesium, 2,6-diethylphenylbutylmagnesium, 2,6-diethylphenylethylmagnesium, 2,6-diisopropylphenylbutylmagnesium, 2,6-disopropylphenylethylmagnesium, 2,4,6-triethylphenylbutylmagnesium, 2,4,6-triethylphenylethylmagnesium, 2,4,6-triisopropylphenylbutylmagnesium, 2,4,6-triisopropylphenylethylmagnesium, 1,3-di(magnesium bromide)propanediyl, 1,3-di(magnesium chloride)propanediyl, 1,5-di(magnesium bromide)pentanediyl, 1,5-di(magnesium chloride)pentanediyl, 1,8-di(magnesium bromide)octanediyl, 1,8-di(magnesium chloride)octanediyl.

The organomagnesium compound of formula (IIc) may be prepared via a process which comprises the reaction of a first organomagnesium reagent of formula X′Mg—R^{A}—MgX′ with a second organomagnesium reagent of formula R^{B}—Mg—X′, in which X′ represents a halogen atom, preferentially bromine or chlorine, R^{B} and R^{A} being as defined previously. X′ is more preferentially a bromine atom. The stoichiometry used in the reaction determines the value of m in formula (IIc). For example, a mole ratio of 0.5 between the amount of the first organomagnesium reagent and the amount of the second organomagnesium reagent is favourable to the formation of an organomagnesium compound of formula (IIc) in which m is equal to 1, whereas a mole ratio of greater than 0.5 will be more favourable to the formation of an organomagnesium compound of formula (IIc) in which m is greater than 1.

To perform the reaction of the first organomagnesium reagent with the second organomagnesium reagent, a solution of the second organomagnesium reagent is typically added to a solution of the first organomagnesium reagent. The solutions of the first organomagnesium reagent and the second organomagnesium reagent are generally solutions in an ether, such as diethyl ether, dibutyl ether, tetrahydrofuran, methyltetrahydrofuran, or a mixture of two or more of these ethers. A hydrocarbon-based aliphatic or aromatic solvent may be added to the ether as a co-solvent. Preferably, the respective concentrations of the solutions of the first organomagnesium reagent and the second organomagnesium reagent are from 0.01 to 3 mol/L and from 0.02 to 5 mol/L, respectively. More preferentially, the respective concentrations of the first organomagnesium reagent and the second organomagnesium reagent are from 0.1 to 2 mol/L and from 0.2 to 4 mol/L, respectively.

The first organomagnesium reagent and the second organomagnesium reagent, which are Grignard reagents, may be prepared beforehand from magnesium metal and a suitable halogenated precursor in a reactor. For the first organomagnesium reagent and the second organomagnesium reagent, the respective precursors are of formulae X′—R^{A}—X′ and R^{B}—X′, R^{A}, R^{B} and X′ being as defined previously. The Grignard reagents are typically prepared by adding the precursor to magnesium metal which is generally in the form of chips. Preferably, iodine (I₂) typically in the form of beads is introduced into the reactor prior to the addition of the precursor to activate the Grignard reaction in a known manner.

Alternatively, the organomagnesium compound of formula (IIc) may be prepared by reacting an organometallic compound of formula M-R^{A}-M and the organomagnesium reagent of formula R^{B}—Mg—X′, where M represents a lithium, sodium or potassium atom, X′, R^{B} and R^{A} being as defined previously. Preferably, M represents a lithium atom, in which case the organometallic compound of formula M-R^{A}-M is an organolithium reagent.

The reaction of the organolithium reagent and of the organomagnesium reagent is typically performed in an ether such as diethyl ether, dibutyl ether, tetrahydrofuran, methyltetrahydrofuran, methylcyclohexane, toluene or a mixture thereof. The reaction is also typically performed at a temperature ranging from 0° C. to 60° C. The placing in contact is preferably performed at a temperature of between 0° C. and 23° C. The placing in contact of the organometallic compound of formula M-R^{A}-M with the organomagnesium reagent of formula R^{B}—Mg—X′ is preferentially performed by adding a solution of the organometallic compound M-R^{A}-M to a solution of the organomagnesium reagent R^{B}—Mg—X′. The solution of the organometallic compound M-R^{A}-M is generally a solution in a hydrocarbon-based solvent, preferably n-hexane, cyclohexane or methylcyclohexane, and the solution of the organomagnesium reagent R^{B}—Mg—X′ is generally a solution in an ether, preferably diethyl ether or dibutyl ether. Preferably, the respective concentrations of the solutions of the organometallic compound and of the organomagnesium reagent M-R^{A}-M and R^{B}—Mg—X′ are from 0.01 to 1 mol/L and from 0.02 to 5 mol/L, respectively. More preferentially, the respective concentrations of the solutions of the organometallic compound and of the organomagnesium reagent M-R^{A}-M and R^{B}—Mg—X′ are from 0.05 to 0.5 mol/L and from 0.2 to 3 mol/L, respectively.

As with any synthesis performed in the presence of organometallic compounds, the syntheses described for the synthesis of the organomagnesium reagents take place under anhydrous conditions under an inert atmosphere, in stirred reactors. Typically, the solvents and the solutions are used under anhydrous nitrogen or argon.

Once the organomagnesium reagent of formula (IIc) has been formed, it is generally recovered in solution after filtration performed under an inert anhydrous atmosphere. It may be stored prior to use in its solution in sealed containers, for example capped bottles, at a temperature of between −25° C. and 23° C.

Compounds of formula (IId) which are Grignard reagents are described, for example, in the book “Advanced Organic Chemistry” by J. March 4th Edition, 1992, pages 622-623 or in the book “Handbook of Grignard Reagents”, Edition Gary S. Silverman, Philip E. Rakita, 1996, pages 502-503. They may be synthesized by placing magnesium metal in contact with a dihalogen compound of formula X—R^{A}—X, R^{A} being as defined according to the invention. For their synthesis, reference may be made, for example, to the collection of volumes of “Organic Synthesis”.

The compounds of formulae (IIa) and (IIb) which are also Grignard reagents are well known, and some of them are even commercial products. For their synthesis, reference may be made, for example, to the collection of volumes of “Organic Synthesis”.

Like any organomagnesium compound, the organomagnesium compound constituting the catalytic system, notably of formula (IIa), (IIb), (IIc) or (IId), may be in the form of a monomer species or in the form of a polymer species. By way of illustration, the organomagnesium reagent (IIc) may be in the form of a monomeric species (R^{B}—(Mg—R^{A})ₘ—Mg—R^{B}), or in the form of a polymeric species (R^{B}—(Mg—R^{A})ₘ—Mg—R^{B})ₚ, where p is an integer greater than 1, notably dimer (R^{B}—(Mg—R^{A})ₘ—Mg—R^{B})₂, where m is as defined previously. Similarly, also by way of illustration, the organomagnesium reagent of formula (IId) may be in the form of a monomeric species (X—Mg—R^{A}—Mg—X)₁ or in the form of a polymeric species (X—Mg—R^{A}—Mg—X)ₚ, p being an integer greater than 1, notably a dimer (X—Mg—R^{A}—Mg—X)₂.

Moreover, whether it is in the form of a monomeric or polymeric species, the organomagnesium reagent may also be in the form of a species coordinated to one or more molecules of a solvent, preferably of an ether such as diethyl ether, tetrahydrofuran or methyltetrahydrofuran.

In formulae (IIb) and (IId), X is preferentially a bromine or chlorine atom.

According to a very preferential variant of the invention, the organomagnesium reagent is an organomagnesium halide, preferably of formula (IIb) or (IId), more preferentially of formula (IIb), even more preferentially of formula (IIb) XMgR⁵, in which X is a chlorine or bromine atom, and R⁵ is an alkyl or aryl, preferentially an alkyl. According to this very preferential variant, R⁵ is advantageously an alkyl containing 2 to 10 carbon atoms, more preferentially ethyl, propyl, butyl, pentyl, hexyl, heptyl or octyl. When the organomagnesium reagent is a halide of an organomagnesium reagent of formula (IIb) or (IId), preferentially of formula (IIb), the process of the invention leads to some of the highest yields of polymer bearing a ketone function at one of its chain ends, compared with the yields obtained using a diorganomagnesium reagent.

The amounts of co-catalyst and of metallocene reacted are such that the ratio between the number of moles of Mg of the co-catalyst and the number of moles of rare-earth metal of the metallocene, neodymium, is preferably from 0.5 to 200 and more preferentially from 1 to less than 20. These preferential ranges may apply to any one of the embodiments of the invention. The range of values extending from 1 to less than 20 is notably more favorable for obtaining copolymers of high molar masses.

According to one embodiment, the catalytic system can be prepared conventionally by a process analogous to that described in patent application WO 2007/054224 A2 or WO 2007/054223 A2. For example, the cocatalyst, in this instance the organomagnesium reagent, and the metallocene are reacted in a hydrocarbon-based solvent typically at a temperature ranging from 20° C. to 80° C. for a period of time of between 5 and 60 minutes. The catalytic system is generally prepared in an aliphatic hydrocarbon-based solvent such as methylcyclohexane, or an aromatic hydrocarbon-based solvent such as toluene. Generally, after its synthesis, the catalytic system is used as is in step a).

According to another embodiment, the catalytic system may be prepared via a process analogous to that described in patent application WO 2017/093654 A1 or in patent application WO 2018/020122 A1: it is said to be of preformed type. For example, the organomagnesium reagent and the metallocene are reacted in a hydrocarbon-based solvent typically at a temperature of from 20° C. to 80° C. for 10 to 20 minutes to obtain a first reaction product, and a preformation monomer is then reacted with this first reaction product at a temperature ranging from 40° C. to 90° C. for 1 hour to 12 hours. The preformation monomer is preferably used in a mole ratio (preformation monomer/metallocene metal) ranging from 5 to 1000, preferentially from 10 to 500. Prior to its use in polymerization, the preformed catalytic system can be stored under an inert atmosphere, notably at a temperature ranging from −20° C. to room temperature (23° C.). According to this second embodiment, the preformed catalytic system has as its basic constituent a preformation monomer chosen from 1,3-dienes, ethylene and mixtures thereof. In other words, the “preformed” catalytic system contains a preformation monomer in addition to the metallocene and the co-catalyst. The 1,3-diene, as preformation monomer, may be 1,3-butadiene, isoprene or a 1,3-diene of formula CH₂=CR⁶—CH═CH₂, the symbol R⁶ representing a hydrocarbon-based group containing 3 to 20 carbon atoms, in particular myrcene or β-farnesene. The preformation monomer is preferentially 1,3-butadiene.

The catalytic system is typically present in a solvent which is preferentially the solvent in which it was prepared, and the concentration of rare-earth metal, i.e. neodymium, of the metallocene is then within a range preferentially from 0.0001 to 0.2 mol/L more preferentially from 0.001 to 0.03 mol/L.

Like any synthesis performed in the presence of an organometallic compound, the synthesis of the metallocene, the synthesis of the organomagnesium reagent and the synthesis of the catalytic system take place under anhydrous conditions under an inert atmosphere. Typically, the reactions are performed starting with anhydrous solvents and compounds under anhydrous nitrogen or argon.

The polymerization of the monomer mixture is preferably performed in solution, continuously or batchwise. The polymerization solvent is typically an aromatic or aliphatic hydrocarbon-based solvent, such as toluene, cyclohexane or methylcyclohexane, or a mixture of two thereof, or even a mixture of the three. The monomer mixture may be introduced into the reactor containing the polymerization solvent and the catalytic system or, conversely, the catalytic system may be introduced into the reactor containing the polymerization solvent and the monomer mixture. The monomer mixture and the catalytic system may be introduced simultaneously into the reactor containing the polymerization solvent, notably in the case of a continuous polymerization. The polymerization is typically performed under anhydrous conditions and in the absence of oxygen, in the optional presence of an inert gas. The polymerization temperature generally ranges from 40 to 150° C., preferentially 40 to 120° C. A person skilled in the art adapts the polymerization conditions, such as the polymerization temperature, the concentration of each of the reagents and the pressure in the reactor, as a function of the monomer mixture composition, the polymerization reactor and the desired microstructure and macrostructure of the copolymer chain.

The polymerization is preferentially performed at constant monomer pressure. Continuous addition of each or one of the monomers may be performed in the polymerization reactor, in which case the polymerization reactor is a fed reactor. This embodiment is most particularly suitable for a statistical incorporation of the monomers. Preferably, the polymerization in step a) is a statistical polymerization, which is reflected by the statistical incorporation of the monomers of the monomer mixture used in step a).

Once the desired degree of monomer conversion has been achieved in the polymerization reaction of step a), step b), which is a functionalization reaction, is performed.

Step b) of the process in accordance with the invention brings a functionalizing agent, a compound containing a nitrile function, into contact with the reaction product of step a).

Preferably, step b) is also performed in a hydrocarbon-based solvent. Advantageously, it is performed in the reaction medium resulting from step a). It is generally performed by adding the compound containing a nitrile function to the reaction product from step a) in its reaction medium with stirring.

Before adding the compound containing a nitrile function, the reactor is preferably degassed and made inert (also said inertized). Degassing the reactor enables residual gaseous monomers to be removed, and also facilitates the addition of the compound containing a nitrile function into the reactor. Making inert the reactor, for example with nitrogen, helps to prevent the carbon-metal bonds present in the reaction medium and necessary for the polymer functionalization reaction from being deactivated. The compound containing a nitrile function may be added neat or diluted in a hydrocarbon-based, aliphatic or aromatic solvent. The compound containing a nitrile function is left in contact with the reaction product from step a), preferably with stirring, for the time required for the polymer chain-end functionalization reaction. The functionalization reaction may typically be monitored by chromatographic analysis to track the consumption of the compound containing a nitrile function. The functionalization reaction is preferentially performed at a temperature ranging from 23° C. to 120° C., preferentially from 40° C. to 100° C.

The functionalization reaction, step b), is preferentially performed with at least one molar equivalent of nitrile function relative to the number of carbon-magnesium bonds per mole of organomagnesium reagent. The ratio between the number of molar equivalents of nitrile function and the number of carbon-magnesium bonds per mole of organomagnesium reagent may vary to a large extent provided that it is at least 1, i.e. at least one molar equivalent of nitrile function is used relative to the number of carbon-magnesium bonds per mole of organomagnesium reagent. An excess of compound containing a nitrile function may be used, but it is preferable to use not more than 3 molar equivalents of nitrile function relative to the number of carbon-magnesium bonds, notably for reasons of cost. For example, in an organomagnesium halide of formula (IIb), such as n-butylmagnesium chloride, there is one carbon-magnesium bond per mole of halide; in the magnesium reagents of formula (IIa), such as butyloctylmagnesium (BOMAG), or in the magnesium reagents of formula (IId), there are two carbon-magnesium bonds per mole of magnesium reagent. One mole of a compound containing a single nitrile function is equivalent to one molar equivalent of nitrile function; one mole of a compound containing two nitrile functions is equivalent to two molar equivalents of nitrile function; more generally, one mole of a compound containing n nitrile functions is equivalent to n molar equivalents of nitrile function, n being an integer greater than or equal to 1.

The compound containing a nitrile function may be an aliphatic compound or an aromatic compound, preferably aromatic, and preferably contains a single nitrile function. The compound containing a nitrile function is typically a compound with a hydrocarbon-based chain substituted with a single nitrile function or with several nitrile functions, preferably a single nitrile function. The hydrocarbon-based chain of the compound containing a nitrile function may also be substituted with another functional group containing one or more heteroatoms chosen from oxygen, sulfur, nitrogen and silicon atoms. The hydrocarbon-based chain of the compound containing a nitrile function may be linear, cyclic or branched.

Preferably, the compound containing a nitrile function contains a second function which is chosen from ether, thioether, protected amine, tertiary amine, alkoxysilane and imidazole functions, which is preferentially an ether function, a tertiary amine function, an alkoxysilane function or an imidazole function.

According to a first embodiment of the invention, the compound containing a nitrile function is an alkane substituted with a nitrile function, preferably a single nitrile function. The length of the hydrocarbon-based chain of the alkane substituted with a nitrile function is not inherently limited, and the number of carbon atoms in the hydrocarbon-based chain may vary widely, for example from 1 to 11 carbon atoms. The choice of an alkane substituted with a nitrile function may be motivated by the fact that it is commercially available or readily synthesized. In particular, ethanenitrile or acetonitrile, propanenitrile or propionitrile, butanenitrile or butyronitrile, pentanenitrile or valeronitrile, hexanenitrile or capronitrile, dodecanenitrile or laurylnitrile are suitable for use.

According to a second embodiment of the invention, the compound containing a nitrile function is an alkane substituted with a nitrile function and also with another function which contains one or more heteroatoms chosen from oxygen, sulfur, nitrogen and silicon atoms and which is other than a nitrile function. According to this embodiment, the compound containing a nitrile function preferentially contains a single nitrile function. The other function is preferentially chosen from ether, thioether, protected amine, tertiary amine and alkoxysilane functions, and more preferentially is a tertiary amine function or an alkoxysilane function. Dialkylaminoalkanenitriles, alkyloxyalkanenitriles, trialkoxysilylalkanenitriles, alkyldialkoxysilylalkanenitrile and dialkylalkoxysilylalkanenitrile, in which the alkyl and alkoxy chains preferentially contain 1 to 2 carbon atoms and the alkane chains preferentially contain 2 to 6 carbon atoms, more preferentially 2 to 3 carbon atoms, are particularly suitable for use. The choice of substituted alkane may be motivated by whether it is commercially available or readily synthesized. Mention may be made in this respect of dimethylaminopropionitrile, dimethylaminobutyronitrile, diethylaminopropionitrile, diethylaminobutyronitrile, methoxypropionitrile, methoxybutyronitrile, ethoxypropionitrile, ethoxybutyronitrile, triethoxysilylpropionitrile, triethoxysilylbutyronitrile, trimethoxysilylpropionitrile, trimethoxysilylbutyronitrile, methyldimethoxysilylpropionitrile, methyldimethoxysilylbutyronitrile, methyldiethoxysilylpropionitrile, methyldimethoxysilylbutyronitrile, ethyldimethoxysilylpropionitrile, ethyldimethoxysilylbutyronitrile, ethyldiethoxysilylpropionitrile, ethyldiethoxysilylbutyronitrile, dimethylmethoxysilylpropionitrile, dimethylmethoxysilylbutyronitrile, dimethylmethoxysilylpropionitrile, dimethylmethoxysilylbutyronitrile, diethylmethoxysilylpropionitrile, diethylmethoxysilylbutyronitrile, diethylethoxysilylpropionitrile and diethylethoxysilylbutyronitrile.

According to a particularly preferential third embodiment, the compound containing a nitrile function is an arene substituted with a nitrile function, preferably a single nitrile function. The arene may also bear one or more other substituents other than a nitrile function. The arene may be substituted with a hydrocarbon-based chain or a functional group which is other than a nitrile function and which contains one or more heteroatoms such as an oxygen atom, a sulfur atom, a nitrogen atom or a silicon atom. The functional group is preferentially chosen from ether, thioether, protected amine, tertiary amine and imidazole functions. The arene may be substituted with a hydrocarbon-based chain which is also substituted with a function chosen from ether, thioether, protected amine, tertiary amine and imidazole functions. The hydrocarbon-based chains in the compound containing a nitrile function are preferentially alkyls. The alkyls in the compound containing a nitrile function preferentially contain 1 to 6 carbon atoms, more preferentially 1 to 3 carbon atoms.

The compound containing a nitrile function is more preferentially a benzonitrile, benzonitrile or substituted benzonitrile, preferentially substituted with a function chosen from ether, thioether, protected amine, tertiary amine and imidazole functions, more preferentially substituted with an ether, tertiary amine or imidazole function. The benzonitrile that is useful for the purposes of the invention is typically of formula (III) in which the symbols X₁ to X₅, which are identical or different, each represent a hydrogen atom, an alkyl or a function which is chosen from ether, thioether, protected amine, tertiary amine and imidazole functions, preferentially which is an ether function, a tertiary amine function or an imidazole function. Advantageously, four of the symbols X₁ to X₅ in formula (III) represent a hydrogen atom or an alkyl, preferably a hydrogen atom, and the fifth symbol represents an ether function, a thioether function, a protected amine function, a tertiary amine function or an imidazole function, preferably an ether function, a tertiary amine function or an imidazole function. The alkyl of the benzonitrile compound preferentially contains from 1 to 6 carbon atoms and more preferentially from 1 to 3 carbon atoms. Benzonitrile and the following substituted benzonitriles are particularly suitable, whether para-, meta- or ortho-substituted, preferably para- or ortho-substituted, for instance alkoxybenzonitriles such as methoxybenzonitrile, ethoxybenzonitrile, thioalkoxybenzonitriles such as thiomethoxybenzonitrile, thioethoxybenzonitrile, N,N-dialkylaminobenzonitrile such as N,N-dimethylaminobenzonitrile, N,N-diethylaminobenzonitrile, imidazolylbenzonitriles such as 2-(1H-imidazol-1-yl)benzonitrile, or 4-(1H-Imidazol-1-ylmethyl)benzonitrile.

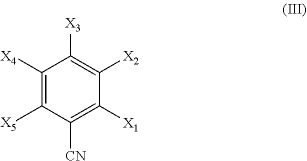

Once the chain end has been modified, step b) is followed by step c). Step c) is typically a hydrolysis reaction which allows formation of the ketone function in the polymer chain and, where appropriate, deactivation of the reactive sites that are still present in the reaction medium. The hydrolysis reaction is generally performed by adding water to the reaction medium or vice versa, optionally in the presence of an acid. Typically, the reaction medium resulting from step b) is brought into contact with an aqueous hydrochloric acid solution. The hydrolysis reaction may be performed at a temperature ranging from 0° C. to 100° C., preferentially at room temperature (23° C.) or at the reaction temperature of step b), or even at a temperature in the range from room temperature to the reaction temperature of step b). In the case where the polymer also contains a protected amine function or an alkoxysilane function, step c) may be followed or accompanied by a hydrolysis reaction of the protected amine function to an amine function or of the alkoxysilane function to a silanol function, as described, for example, in patent application EP 2 266 819 A1.

On conclusion of step c), the polymer may be separated from the reaction medium according to processes well known to those skilled in the art, for example by a solvent evaporation operation under reduced pressure or by a steam stripping operation. According to a variant of the invention, step c) and the separation of the polymer from the reaction medium may be performed in the same operation, for example a steam stripping operation, notably in the presence of an acid.

The polymers which may be synthesized via the process in accordance with the invention have the feature of bearing at the chain end, i.e. at one of its chain ends, a ketone function, notably a ketone function whose CO group is attached directly to a monomer unit of the polymer. The expression “a ketone function whose CO group is attached directly to a monomer unit of the polymer” means a ketone function in which the carbon of the CO group of the ketone function is engaged in a covalent bond with a carbon atom of a monomer unit of the polymer. Preferably, the polymers bear a second function which is borne on the same chain end as the ketone function and is chosen from ether, thioether, amine, alkoxysilane, silanol and imidazole functions. The second function is preferably an amine function, preferably a tertiary amine function, an alkoxysilane function, a silanol function or an imidazole function, more preferentially a tertiary amine function, a silanol function or an imidazole function. The alkoxysilane function is advantageously of the formula Si(OR)₃₋ₙRₙ, R, which are identical or different, being methyl or ethyl, and n being an integer ranging from 0 to 3.

According to a first variant, the polymer bears a ketone function at only one of its chain ends. This variant may be performed via the synthetic process in accordance with the invention in which the organomagnesium reagent is of formulae (IIa) and (IIb).

According to a second variant, the polymer bears a ketone function at each of its chain ends.

This variant may be performed via the synthetic process in accordance with the invention in which the organomagnesium reagent is of formulae (IIc) and (IId).

According to a first mode applicable to the first variant and to the second variant, the ketone function is a substituent of an aliphatic hydrocarbon-based chain. The hydrocarbon-based chain may be linear, cyclic or branched. The hydrocarbon-based chain is preferentially an alkyl containing from 1 to 11 carbon atoms. Particularly suitable hydrocarbon-based chains include ethyl, propyl, pentyl and lauryl. The polymers defined according to this first mode may be prepared via the first embodiment of the process in accordance with the invention.

According to a second mode applicable to the first variant and to the second variant, the ketone function is a substituent of an aliphatic hydrocarbon-based chain which is also substituted with another function which contains one or more heteroatoms chosen from an oxygen atom, a sulfur atom, a nitrogen atom and a silicon atom and which is other than a ketone function. The other function is preferentially chosen from ether, thioether and amine functions, more preferentially a tertiary amine function, an alkoxysilane function or a silanol function, even more preferentially a tertiary amine function or a silanol function. The polymers defined according to this second mode may be prepared by performing the second embodiment of the process in accordance with the invention.

According to a third mode applicable to the first variant and to the second variant, the ketone function is a substituent of an aryl, preferably phenyl. The aryl group may also be substituted with a hydrocarbon-based chain or a functional group which is other than a nitrile function and which contains one or more heteroatoms such as an oxygen atom, a sulfur atom, a nitrogen atom or a silicon atom. The functional group is preferentially chosen from ether, thioether and amine functions, preferably tertiary amine and imidazole. The arene may be substituted with a hydrocarbon-based chain which is also substituted with a function chosen from ether, thioether, amine, preferably tertiary amine functions. The hydrocarbon-based chains substituting the aryl group, in particular phenyl, are preferentially alkyls. These alkyls preferentially contain from 1 to 6 carbon atoms and more preferentially from 1 to 3 carbon atoms. The polymers defined according to this third mode may be prepared by performing the third mode embodiment of the process in accordance with the invention.

According to a fourth mode applicable to the first variant and to the second variant, the ketone function is a substituent of an alkyl-substituted phenyl or a function which is chosen from ether, thioether and amine, preferably tertiary amine and imidazole functions, which is preferably an ether function, a tertiary amine function or an imidazole function. The alkyl substituent on the phenyl preferentially contains from 1 to 6 carbon atoms and more preferentially from 1 to 3 carbon atoms. The polymers defined in this fourth mode may be prepared by performing the third embodiment of the process in accordance with the invention, in which the compound containing a nitrile function is a substituted benzonitrile.

The second subject of the invention is a copolymer of ethylene, a 1,3-diene and optionally a vinylaromatic compound, which copolymer bears at one of its chain ends a ketone function and optionally a second function which is borne on the same chain end as the ketone function and which is chosen from ether, thioether, amine, alkoxysilane, silanol and imidazole functions. It may be obtained via the process in accordance with the invention according to the alternative in which the ethylene-containing monomer mixture to be polymerized is a mixture of ethylene, a 1,3-diene and optionally a vinylaromatic compound. The two variants described previously which define the polymers that may be obtained via the process in accordance with the invention, and also the four modes described as applicable to these two variants can be applied to the copolymer, which is the second subject of the invention. The amine function borne by the copolymer in accordance with the invention is preferentially a tertiary amine function.

The copolymer also has the essential feature of containing more than 50 mol % of ethylene units, the percentage being expressed relative to all the units resulting from polymerization of the monomers of the monomer mixture, in this case ethylene, 1,3-diene and, where appropriate, the vinylaromatic compound. The 1,3-diene and the vinylaromatic compound are as defined in any one of the embodiments of the process in accordance with the invention.

Preferably, the copolymer also contains 1,2-cyclohexane ring units. The 1,2-cyclohexane ring units are of formula (IV).

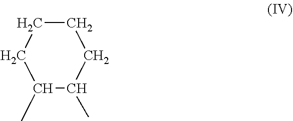

When the copolymer contains 1,2-cyclohexane ring units, it is a copolymer according to a particular embodiment of the invention in which the 1,3-diene is 1,3-butadiene or a mixture of 1,3-dienes, one of which is 1,3-butadiene and in which the ring units result from a particular insertion of the ethylene and 1,3-butadiene monomers into the polymer chain, in addition to the conventional ethylene and 1,3-butadiene units —(CH₂—CH₂)—, (CH₂—CH═CH—CH₂)— and (CH₂—CH(C═CH₂))— respectively. It is notably obtained via the process in accordance with the invention according to the embodiment in which the metallocene of the catalytic system has two substituted or unsubstituted fluorenyl groups as ligands. The mechanism for obtaining such a microstructure is described, for example, in Macromolecules 2009, 42, 3774-3779. When the polymer in accordance with the invention contains 1,2-cyclohexane ring units, it preferentially contains not more than 15 mol % thereof, the percentage being expressed relative to the total units resulting from polymerization of the monomers in the monomer mixture.

According to any one of the embodiments of the invention, the copolymer in accordance with the invention is preferentially a statistical copolymer.

The third subject of the invention is a polyethylene which bears at one of its chain ends a ketone function and a second function which is borne on the same chain end as the ketone function and which is chosen from ether, thioether, amine, alkoxysilane, silanol and imidazole functions. It may be obtained via the process in accordance with the invention according to the alternative in which the ethylene-containing monomer mixture to be polymerized is a monomer mixture consisting solely of ethylene. The two variants described previously which define the polymers that may be obtained by the process in accordance with the invention, and combined with the second mode or fourth mode described as applicable to these two variants can be applied to polyethylene, which is the third subject of the invention. The amine function borne by the polyethylene in accordance with the invention is preferentially a tertiary amine function.

The polymer in accordance with the invention, whether it is a copolymer or a polyethylene, respectively the second subject of the invention and the third subject of the invention, can be used in compositions containing one or more ingredients or constituents other than the polymer in accordance with the invention, for example additives conventionally used in polymer compositions, such as antioxidants, plasticizers, pigments or fillers.

In summary, the invention is advantageously performed according to any one of the following embodiments 1 to 34:
Embodiment 1: Process for preparing a polymer containing more than 50 mol % of ethylene units and bearing a ketone function at one of its chain ends, which process comprises the successive steps a), b) and c)
step a) being the polymerization of an ethylene-containing monomer mixture in the presence of a catalytic system based on at least one metallocene of formula (I) and an organomagnesium reagent

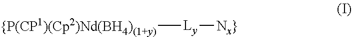

Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom, Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
step b) being the reaction of a compound containing a nitrile function with the product of the polymerization reaction of step a),
step c) being a hydrolysis reaction, the polymer being a polyethylene or a copolymer of ethylene and a 1,3-diene and optionally a vinylaromatic compound.

Embodiment 2: Process according to embodiment 1, in which the 1,3-diene monomer is 1,3-butadiene, isoprene, myrcene, β-farnesene or mixtures thereof.

Embodiment 3: Process according to embodiment 1 or 2, in which the monomer mixture is ethylene.

Embodiment 4: Process according to embodiment 1 or 2, in which the monomer mixture is a mixture of ethylene and a 1,3-diene.

Embodiment 5: Process according to embodiment 1 or 2, in which the monomer mixture is a mixture of ethylene, a 1,3-diene and a vinylaromatic compound.

Embodiment 6: Process according to embodiment 5, in which the vinylaromatic compound is styrene.

Embodiment 7: Process according to any one of embodiments 1 to 6, in which the monomer mixture of step a) contains more than 50 mol % of ethylene, the percentage being expressed relative to the total number of moles of monomers in the monomer mixture of step a).

Embodiment 8: Process according to any one of embodiments 1 to 7, in which Cp¹ and Cp², which are identical or different, are substituted fluorenyl groups or unsubstituted fluorenyl groups of formula C₁₃H₈, preferably unsubstituted fluorenyl groups.

Embodiment 9: Process according to any one of embodiments 1 to 8, in which the metallocene is of formula (I-1). (I-2). (I-3). (I-4) or (I-5):

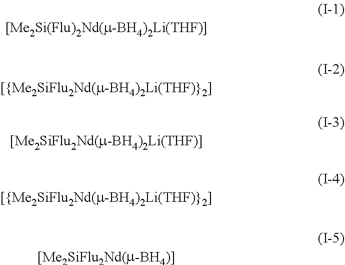

in which Flu represents the C₁₃H₈ group.

Embodiment 10: Process according to any one of embodiments 1 to 9, in which the organomagnesium reagent is of formula (IIa), (IIb), (IIc) or (IId) in which R³, R⁴, R⁵ and R^{B}, which are identical or different, represent a carbon-based group, R^{A} represents a divalent carbon-based group, X is a halogen atom, and m is a number greater than or equal to 1, preferably equal to 1.

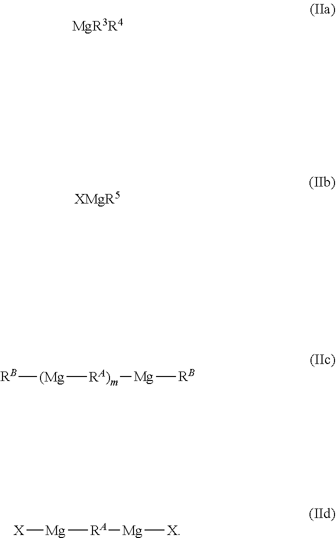

Embodiment 11: Process according to embodiment 10, in which R^{A} is a divalent aliphatic hydrocarbon-based chain, optionally interrupted with one or more oxygen or sulfur atoms or with one or more arylene groups.

Embodiment 12: Process according to embodiment 10 or 11, in which R^{A} is a branched or linear alkanediyl, a cycloalkanediyl or a xylenediyl radical.

Embodiment 13: Process according to any one of embodiments 10 to 12, in which R^{A} is an alkanediyl containing 3 to 8 carbon atoms.

Embodiment 14: Process according to any one of embodiments 10 to 13, in which R^{B} comprises a benzene nucleus substituted with a magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl.

Embodiment 15: Process according to embodiment 14, in which R^{B} is 1,3-dimethylphenyl, 1,3-diethylphenyl, mesityl, or 1,3,5-triethylphenyl.

Embodiment 16: Process according to embodiment 10, in which R³ comprises a benzene nucleus substituted with a magnesium atom, one of the carbon atoms of the benzene nucleus ortho to the magnesium being substituted with a methyl, an ethyl, an isopropyl or forming a ring with the carbon atom which is its closest neighbour and which is meta to the magnesium, the other carbon atom of the benzene nucleus ortho to the magnesium being substituted with a methyl, an ethyl or an isopropyl and R⁴ is an alkyl.

Embodiment 17: Process according to embodiment 16, in which R³ is 1,3-dimethylphenyl, 1,3-diethylphenyl, mesityl, or 1,3,5-triethylphenyl and R⁴ is ethyl, butyl or octyl.

Embodiment 18: Process according to embodiment 10, in which R³ and R⁴ are alkyls containing 2 to 10 carbon atoms.

Embodiment 19: Process according to embodiment 10, in which R⁵ is an alkyl containing 2 to 10 carbon atoms.

Embodiment 20: Process according to any one of embodiments 10 to 13 or 19, in which X is a bromine or chlorine atom.

Embodiment 21: Process according to any one of embodiments 10 to 13 or 19 to 20, in which the organomagnesium reagent is an organomagnesium halide, preferably of formula (IIb) or (IId) defined in embodiment 10.

Embodiment 22: Process according to any one of embodiments 10 to 13 or 19 to 21, in which the organomagnesium reagent is an organomagnesium halide of formula XMgR⁵, x being a chlorine atom or a bromine atom, R⁵ being an alkyl or an aryl.

Embodiment 23: Process according to any one of embodiments 10 to 13 or 19 to 22, in which the organomagnesium reagent is an organomagnesium halide of formula XMgR⁵, X being a chlorine or bromine atom, R⁵ being an alkyl containing 2 to 10 carbon atoms.

Embodiment 24: Process according to any one of embodiments 10 to 13 or 19 to 23, in which the organomagnesium reagent is an organomagnesium halide of formula XMgR⁵, X being a chlorine or bromine atom, R⁵ being ethyl, propyl, butyl, pentyl, hexyl, heptyl or octyl.

Embodiment 25: Process according to any one of embodiments 1 to 24, in which the compound containing a nitrile function contains a single nitrile function.

Embodiment 26: Process according to any one of embodiments 1 to 25, in which the compound containing a nitrile function is a nitrile-substituted alkane, preferably containing from 1 to 11 carbon atoms.

Embodiment 27: Process according to any one of embodiments 1 to 25, in which the compound containing a nitrile function is an arene substituted with a nitrile function, preferably benzonitrile.

Embodiment 28: Process according to any one of embodiments 1 to 25, in which the compound containing a nitrile function is a compound which contains a second function which is chosen from ether, thioether, protected amine, tertiary amine, alkoxysilane and imidazole functions, preferably an ether function, a tertiary amine function, an alkoxysilane function or an imidazole function.

Embodiment 29: Process according to any one of embodiments 1 to 25, in which the compound containing a nitrile function is an alkane substituted with a nitrile function and with a function which is chosen from ether, thioether, protected amine, tertiary amine and alkoxysilane functions, preferably a tertiary amine function or an alkoxysilane function.

Embodiment 30: Process according to any one of embodiments 1 to 25, in which the compound containing a nitrile function is an arene substituted with a nitrile function, preferentially a substituted benzonitrile.

Embodiment 31: Process according to any one of embodiments 1 to 25, in which the compound containing a nitrile function is a benzonitrile substituted with a function chosen from ether, thioether, protected amine, tertiary amine and imidazole functions, preferably an ether function, a tertiary amine function or an imidazole function.

Embodiment 32: Process according to any one of embodiments 1 to 31, in which step b) is performed with at least one molar equivalent of nitrile function relative to the number of carbon-magnesium bonds per mole of organomagnesium reagent.

Embodiment 33: Polymer containing more than 50 mol % of ethylene units and bearing at one of its chain ends a ketone function and optionally a second function which is borne on the same chain end as the ketone function and which is chosen from ether, thioether, amine, alkoxysilane, silanol and imidazole functions, which polymer is a copolymer of ethylene and a 1,3-diene or a copolymer of ethylene, a 1,3-diene and a vinylaromatic compound.

Embodiment 34: Polyethylene bearing at one of its chain ends a ketone function and a second function which is borne on the same chain end as the ketone function and which is chosen from ether, thioether, amine, alkoxysilane, silanol and imidazole functions.

The abovementioned features of the present invention, and also others, will be understood more clearly on reading the following description of implementation examples of the invention, which are given as non-limiting illustrations.

### EXAMPLES

### Characterization of the Polymers:

### High Temperature Size Exclusion Chromatography (HT-SEC) to Characterize the Polyethylenes:

The high temperature size exclusion chromatography (HT-SEC) analyses were performed with a Viscotek machine (Malvern Instruments) equipped with three columns (PLgel Olexis 300 mm×7 mm I. D. from Agilent Technologies) and three detectors (differential refractometer and viscometer, and light scattering). 200 μL of a solution of the sample at a concentration of 8 mg·mL⁻¹ were eluted in 1,2,4-trichlorobenzene using a flow rate of 1 mL·min⁻¹ at 150° C. The mobile phase was stabilized with 2,6-di(tert-butyl)-4-methylphenol (400 mg·L⁻¹). OmniSEC software was used for data acquisition and analysis. The number-average molar mass (Mₙ) and weight-average molar mass (M_{w}) of the synthesized polyethylenes were calculated using a calibration curve obtained from standard polyethylenes (Mp: 338, 507, 770, 1890, 17 000, 27 300, 43 400, 53 100, 65 700, 78 400 g·mol⁻¹) from Polymer Standard Service (Mainz).

### Size Exclusion Chromatography (SEC-THF) to Characterize the Ethylene/1,3-Butadiene Copolymers:

The size exclusion chromatography analyses were performed using a Viscotek machine (Malvern Instruments) equipped with three columns (SDVB, 5 μm, 300×7.5 mm from Polymer Standard Service), a guard column and three detectors (differential refractometer and viscometer, and light scattering). 1 mL of a solution of the sample with a concentration of 5 mg·mL⁻¹ in THF was filtered through a 0.45 μm PTFE membrane. 100 μL of this solution were eluted in THF using a flow rate of 0.8 mL·min⁻¹ at a temperature of 35° C. OmniSEC software was used for data acquisition and analysis. The number-average molar mass (Mₙ) and weight-average molar mass (M_{w}) of the synthesized ethylene/1,3-butadiene copolymers and the dispersity thereof (Ð) were calculated using a universal calibration curve obtained from standard polystyrenes (Mp: 1306 to 2 520 000 g·mol⁻¹) from Polymer Standard Service (Mainz).

### Nuclear Magnetic Resonance (NMR):

High resolution NMR spectroscopy of the polymers was performed on a Bruker 400 Avance III spectrometer operating at 400 MHz equipped with a 5 mm BBFO probe for proton and on a Bruker 400 Avance II spectrometer operating at 400 MHz equipped with a 10 mm PSEX ¹³C probe for carbon. Acquisitions were made in a mixture of tetrachloroethylene (TCE) and deuterated benzene (C₆D₆) (2/1 v/v) at 363 K for the ethylene homopolymers, and in deuterated chloroform (CDCl₃) at 298 K for the ethylene/1,3-butadiene copolymers. The samples were analysed at a concentration of 1% by mass for proton and 5% by mass for carbon. The chemical shifts are given in ppm, relative to the deuterated benzene proton signal set at 7.16 ppm (or, respectively, relative to deuterated chloroform at 7.26 ppm) and the TCE carbon signal set at 120.65 ppm.

### Preparation of the Polymers:

The metallocene [{Me₂SiFlu₂Nd(μ-BH₄)₂Li(THF)}]₂ is prepared according to the procedure described in patent application WO 2007/054224.

The butyloctylmagnesium BOMAG (20% in heptane, at 0.88 mol·L⁻¹) is obtained from Chemtura and is stored in a Schlenk tube under an inert atmosphere.

Unless otherwise indicated, the magnesium halides are from Sigma-Aldrich.

The ethylene, of N35 grade, is obtained from the company Air Liquide and is used without prior purification.

The 1,3-butadiene is purified over alumina guard tubes. The toluene and methylcyclohexane are purified over alumina guard tubes.

The 4-methoxybenzonitrile is from Sigma-Aldrich.

In the procedures described, the term “cannulate” means to transfer using a cannula.

### Synthesis of Functional Polyethylenes Bearing a Chain-End Ketone:

### Example PE1

198 mL of toluene taken from a solvent fountain (SPS800 MBraun) are placed in an inertized 250 mL round-bottomed flask equipped with a magnetized olive. 2.0 ml of a 2.0 M solution of butylmagnesium chloride in diethyl ether are placed in the flask with stirring. 8.0 mg (12.5 μmol as neodymium) of {(Me₂Si(C₁₃H₈)₂)Nd(μ-BH₄)[(μ-BH₄)Li(THF)]}₂ are then added to the flask. The catalytic solution is cannulated into a 250 mL reactor under an inert atmosphere. The pressure in the reactor is reduced to 0.5 bar and the reactor is then pressurized to 4 bar of ethylene and the temperature is simultaneously brought to 80° C. The pressure is kept constant in the reactor by means of a tank containing ethylene. When the desired amount of ethylene has been consumed, in this case after 15 min, the reactor is degassed and 10 mL (5%) of the polymer solution are cannulated out of the reactor and the polymer thus collected is then precipitated from methanol, recovered by filtration and dried under vacuum at 80° C. It is designated PE1NF. 10 ml of a degassed solution, stored over molecular sieves, of benzonitrile at 0.38 M in toluene (3.8 mmol, 1 molar equivalent of nitrile function/carbon-Mg bond) are added to the polymer solution remaining in the reactor. After 40 min of stirring at 80° C., 3 mL of aqueous 15% hydrochloric acid solution are added to deactivate the system, and the temperature is reduced to 20° C. The polymer solution is poured onto methanol with stirring to precipitate the polymer. The precipitated polymer is filtered off, washed with methanol and then dried under vacuum at 80° C. and characterized.

4.68 g of polymer PE1F of formula H—(CH₂—CH₂)ₙ—C(O)—(C₆H₅) and 0.21 g of polymer PE1NF of formula H—(CH₂—CH₂)ₙ—H from the sample collected prior to the functionalization reaction are recovered. The proton NMR spectrum of polymer PE1F (TCE/C₆D₆ 2/1 v/v, 400 MHZ, 363 K) reveals the protons a to the ketone formed at δ=2.70 ppm (triplet, CH₃—(CH₂—CH₂)ₙ—CH₂—C(O)—(C₆H₅)). The function content in polymer PE1F is calculated by normalizing the sum of the chain-end signal integrals of the NMR spectrum to 2. Thus in PE1F, 93% of the polymer chain ends have been functionalized with a ketone. No side products were identified by NMR.

### Example PE2

The synthesis of polymer PE2 is identical to that described in Example PE1, except that the 2.0 mL of a 2.0 M solution of butylmagnesium chloride in diethyl ether are replaced with 2.0 mL of a 2.0 M solution of pentylmagnesium bromide in diethyl ether.

4.21 g of polymer PE2F of formula H—(CH₂—CH₂)ₙ—C(O)—(C₆H₅) and 0.29 g of polymer PE2NF of formula H—(CH₂—CH₂)ₙ—H from the sample collected prior to the functionalization reaction are recovered. In PE2F, 89% of the polymer chain ends have been functionalized with a ketone. No side products were identified by NMR.

### Example PE3

The synthesis of polymer PE3 is identical to that described in Example PE1, except that the 2.0 mL of a 2.0 M solution of butylmagnesium chloride in diethyl ether are replaced with 2.0 mL of a 2.0 M solution of pentylmagnesium bromide in diethyl ether, the functionalization reaction is performed by adding benzonitrile up to 3 molar equivalents of nitrile function/carbon-Mg bond at the end of polymerization, and the deactivation reaction is performed after 10 minutes of stirring at 80° C.

3.8 g of polymer PE3F of formula H—(CH₂—CH₂)ₙ—C(O)—(C₆H₅) and 0.24 g of polymer PE3NF of formula H—(CH₂—CH₂)ₙ—H from the sample collected prior to the functionalization reaction are recovered. In PE3F, 93% of the polymer chain ends have been functionalized with a ketone. No side products were identified by NMR.

### Example PE4

The synthesis of polymer PE4 is identical to that described in Example PE1, except that the 2.0 mL of a 2.0 M solution of butylmagnesium chloride in diethyl ether are replaced with 2.0 ml of a 2.0 M solution of pentylmagnesium bromide in diethyl ether, the functionalization reaction is performed by adding benzonitrile (3 molar equivalents of nitrile function/carbon-Mg bond) in solution in 5 mL of methyltetrahydrofuran, and the deactivation reaction is performed after 10 minutes of stirring at 80° C.

3.97 g of polymer PE4F of formula H—(CH₂—CH₂)ₙ—C(O)—(C₆H₅) and 0.29 g of polymer PE4NF of formula H—(CH₂—CH₂)ₙ—H from the sample collected prior to the functionalization reaction are recovered. In PE4F, 88% of the polymer chain ends have been functionalized with a ketone. No side products were identified by NMR.

### Example PE5

The synthesis of polymer PE5 is identical to that described in Example PE1, except that the 2.0 mL of a 2.0 M solution of butylmagnesium chloride in diethyl ether are replaced with 2.0 mL of a 2.0 M solution of pentylmagnesium bromide in diethyl ether, the functionalization reaction is performed by adding benzonitrile (3 molar equivalents of nitrile function/carbon-Mg bond) in solution in 5 mL of methyltetrahydrofuran, and the deactivation reaction is performed after 10 minutes of stirring at 90° C.

4.35 g of polymer PE5F of formula H—(CH₂—CH₂)ₙ—C(O)—(C₆H₅) and 0.20 g of polymer PE5NF of formula H—(CH₂—CH₂)ₙ—H from the sample collected prior to the functionalization reaction are recovered. In PE5F, 86% of the polymer chain ends have been functionalized with a ketone. No side products were identified by NMR.

### Example PE6

The synthesis of polymer PE6 is identical to that described in Example PE1, except that the 2.0 mL of a 2.0 M solution of butylmagnesium chloride in diethyl ether are replaced with 2.5 mL of a solution of 1,5-di(magnesium bromide)pentanediyl synthesized in methyltetrahydrofuran and then diluted to 0.4 M in toluene (1.0 mmol, 5 mM in toluene), and the functionalization reaction is performed by adding 5 mL of a degassed solution, stored over molecular sieves, of benzonitrile at 0.38 M in toluene (1.9 mmol, 1 molar equivalent of nitrile function/carbon-Mg bond). 3.83 g of polymer PE6F of formula (C₆H₅)—C(O)—(CH₂—CH₂)ₙ—C(O)—(C₆H₅) (telechelic polymer) or H—(CH₂—CH₂)ₙ—C(O)—(C₆H₅) (monofunctional polymer) and 0.26 g of polymer PE6NF of formula H—(CH₂—CH₂)ₙ—H from the sample collected prior to the functionalization reaction are recovered. In PE6F, 22% of the polymer chain ends are non-functional and 78% of the polymer chain ends have been functionalized with a ketone, corresponding to 42% monofunctional chains and 18% telechelic chains. No side products were identified by NMR.

1,5-Di(Magnesium Bromide)Pentanediyl is Prepared According to the Following Procedure: 9.72 g of magnesium (400 mmol, 10 equivalents), 80 mL of MeTHF (of which 64 mL in the dropping funnel), 60 mg of diiodine (0.23 mmol, 0.006 equivalent) and 5.45 mL of 1,5-dibromopentane (40 mmol, 1 equivalent) were used in the synthesis. The glassware used consisted of a 200 mL flask and a 100 mL dropping funnel. Once the synthesis of the Grignard reagent is complete, the solution is transferred through the filter cannula into a second inertized 200 mL flask. This solution is concentrated under vacuum and then diluted in 55 mL of toluene. The concentration of pentanediyl group is estimated at 0.4 mol L′1. This oil is immiscible in methylcyclohexane.

Aliquot of the concentrated oil: 1H NMR (Toluene-D₈-500 MHz-298 K) δ: ppm=2.21 (quint, J=7.2 Hz, “b”), 1.88 (quint, J=7.0 Hz, “c”), 0.11 (t, J=7.4 Hz, “a”); quint for quintet.

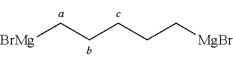

### Example PE7

The synthesis of polymer PE7 is identical to that described in Example PE1, except that:
the 198 mL of toluene are replaced with 196 mL of toluene and 2 mL of diethyl ether,
the functionalization reaction is performed by adding 10 mL of a degassed solution, stored over molecular sieves, of 0.38 M 4-methoxybenzonitrile in toluene (3.8 mmol, 1 molar equivalent of nitrile function/carbon-Mg bond)
and the deactivation reaction is performed after 60 min of stirring at 80° C.

4.17 g of polymer PE7F of formula H—(CH₂—CH₂)ₙ—C(O)—(C₆H₄)—OCH₃ and 0.23 g of polymer PE7NF of formula H—(CH₂—CH₂)ₙ—H from the sample collected prior to the functionalization reaction are recovered. In PE7F, 89% of the polymer chain ends have been functionalized with a ketone. No side products were identified by NMR.

### Example PE8

The synthesis of polymer PE8 is identical to that described in Example PE7, except that the 2.0 mL of a 2.0 M solution of butylmagnesium chloride in diethyl ether are replaced with 2.0 mL of a 2.0 M solution of pentylmagnesium bromide in diethyl ether.

4.27 g of polymer PE8F of formula H—(CH₂—CH₂)ₙ—C(O)—(C₆H₄)—OCH₃ and 0.16 g of polymer PE8NF of formula H—(CH₂—CH₂)ₙ—H from the sample collected prior to the functionalization reaction are recovered. In PE8F, 82% of the polymer chain ends have been functionalized with a ketone. No side products were identified by NMR.

### Example PE9

The synthesis of polymer PE9 is identical to that described in Example PE7, except that:
the 196 mL of toluene are replaced with 194 mL of toluene,
the 2.0 mL of a 2.0 M solution of butylmagnesium chloride in diethyl ether are replaced with 4.0 mL of a 1.0 M solution of mesitylmagnesium bromide in diethyl ether,
2.4 mL of a 1.6 M solution of n-butyllithium in hexane (3.84 mmol, 19.2 mM) are added after the mesitylmagnesium bromide solution and before the introduction of the metallocene,
20 ml of polymer solution instead of 10 ml are collected prior to the functionalization reaction,
the functionalization reaction is performed by adding 18.5 mL of a degassed solution, stored over molecular sieves, of 0.38 M 4-methoxybenzonitrile in toluene (7.0 mmol),
and the deactivation reaction is performed after 1 h of stirring at 80° C. by pouring the polymer solution onto methanol with stirring to precipitate the polymer.

5.02 g of polymer PE9F of formula H—(CH₂—CH₂)ₙ—C(O)—(C₆H₄)—OCH₃ and 0.18 g of polymer PE9NF of formula H—(CH₂—CH₂)ₙ—H from the sample collected prior to the functionalization reaction are recovered. In PE9F, 35% of the polymer chain ends are non-functional, and 52% of the polymer chain ends have been functionalized with a ketone.

### Example PE10

The synthesis of polymer PE10 is identical to that described in Example PE7, except that:
the 196 mL of toluene are replaced with 194 mL of toluene,
the 2 mL of diethyl ether are replaced with 4 mL of diethyl ether,
the 2.0 mL of a 2.0 M solution of butylmagnesium chloride in diethyl ether are replaced with 2.27 mL of a 0.88 M solution of butyloctylmagnesium (BOMAG) in hexane.
the functionalization reaction is performed by adding 10 mL of a degassed solution, stored over molecular sieves, of 0.38 M 4-methoxybenzonitrile in toluene (3.8 mmol, 1 molar equivalent of nitrile function/carbon-Mg bond).

4.55 g of polymer PE10F of formula H—(CH₂—CH₂)ₙ—C(O)—(C₆H₄)—OCH₃ and 0.18 g of polymer PE10NF of formula H—(CH₂—CH₂)ₙ—H from the sample collected prior to the functionalization reaction are recovered. In PE10F, 48% of the polymer chain ends are non-functional, and 46% of the polymer chain ends have been functionalized with a ketone.

### Example PE11

The synthesis of polymer PE11 is identical to that described in Example PE7, except that:
the 196 mL of toluene and the 2 mL of diethyl ether are replaced with 198 mL of toluene,
the 2.0 mL of a 2.0 M solution of butylmagnesium chloride in diethyl ether are replaced with 2.27 mL of a 0.88 M solution of BOMAG in hexane.

3.65 g of polymer PE11F of formula H—(CH₂—CH₂)ₙ—C(O)—(C₆H₄)—OCH₃ and 0.24 g of polymer PE11NF of formula H—(CH₂—CH₂)ₙ—H from the sample collected prior to the functionalization reaction are recovered. In PE11F, 44% of the polymer chain ends are non-functional, and 49% of the polymer chain ends have been functionalized with a ketone.

### Example PE12

The synthesis of polymer PE12 is identical to that described in Example PE1, except that the functionalization reaction is performed by adding 10 ml of a degassed 0.38 M solution, stored over molecular sieves, of valeronitrile in toluene (3.8 mmol, 1 molar equivalent of nitrile function/carbon-Mg bond).

4.48 g of polymer PE12F of formula H—(CH₂—CH₂)ₙ—C(O)—(C₄H₉) and 0.27 g of polymer PE12NF of formula H—(CH₂—CH₂)ₙ—H from the sample collected prior to the functionalization reaction are recovered. In PE12F, 2% of the polymer chain ends are non-functional, and 98% of the polymer chain ends have been functionalized with a ketone. No side products were visible by NMR.

### Example PE13

The synthesis of polymer PE13 is identical to that described in Example PE1, except that:
the 2.0 mL of a 2.0 M solution of butylmagnesium chloride in diethyl ether are replaced with 2.27 mL of a 0.88 M solution of butyloctylmagnesium (BOMAG) in hexane.
the functionalization reaction is performed by adding 10 ml of a degassed 0.38 M solution, stored over molecular sieves, of valeronitrile in toluene (3.8 mmol, 1 molar equivalent of nitrile function/carbon-Mg bond).

3.59 g of polymer PE13F of formula H—(CH₂—CH₂)ₙ—C(O)—(C₄H₉) and 0.26 g of polymer PE13NF of formula H—(CH₂—CH₂)ₙ—H from the sample collected prior to the functionalization reaction are recovered. In PE13F, 51% of the polymer chain ends are non-functional, and 43% of the polymer chain ends have been functionalized with a ketone.

The conditions for the polymerization of ethylene are given in Table 1. Table 1 also shows for each example the mean catalytic activity expressed in kg·mol⁻¹·h⁻¹. The characteristics of the synthesized polyethylenes are shown in Table 2.

### Synthesis of Functional Ethylene/Butadiene Copolymers Bearing a Chain-End Ketone:

### Example EBR1

199 mL of toluene taken from a solvent fountain (SPS800 MBraun) are placed in an inertized 250 mL round-bottomed flask equipped with a magnetized olive. 1.0 ml of a 2.0 M solution of butylmagnesium chloride in diethyl ether is placed in the flask with stirring. 32.0 mg (50 μmol as neodymium) of {(Me₂Si(C₁₃H₈)₂)Nd(μ-BH₄)[(μ-BH₄)Li(THF)]}₂ are then added to the flask. The catalytic solution is cannulated into a 250 mL reactor under an inert atmosphere. The pressure in the reactor is reduced to 0.5 bar, and the reactor is then pressurized to 4 bar with an 80/20 mol/mol ethylene/butadiene mixture and the temperature is simultaneously brought to 80° C. The pressure is kept constant in the reactor by means of a tank containing an 80/20 mol/mol ethylene/butadiene gas mixture. When the desired amount of monomers has been consumed, in this case after 35 min, the reactor is degassed and the temperature is reduced to 20° C. 10 mL (5%) of the polymer solution are cannulated out of the reactor and the polymer is then precipitated from methanol containing 2,6-di-tert-butyl-4-methylphenol, washed with methanol and dried under vacuum at 80° C. It is designated EBR1NF.

5 mL of a degassed solution, stored over molecular sieves, of 4-methoxybenzonitrile at 0.38 M in toluene (1.9 mmol, 1 molar equivalent of nitrile function/carbon-Mg bond) are added to the polymer solution remaining in the reactor. After stirring for 1 h at 80° C., 3 mL of aqueous 15% hydrochloric acid solution are added to deactivate the system. The polymer solution is poured onto methanol with stirring to precipitate the polymer. The precipitated polymer is filtered off, washed with methanol and then dried under vacuum at 80° C. and characterized. 2.92 g of polymer EBR1F and 0.17 g of polymer EBR1NF from the sample collected prior to the functionalization reaction are thus recovered. The proton NMR spectrum of polymer EBR1F (CDCl₃, 400 MHZ, 298 K) reveals the methylene protons a to the various ketones formed at δ=2.5-3.8 ppm, depending on the structure of the monomer units making up the polymer chain end, to which the CO group of the ketone function is bonded, the OCH₃ protons and the aromatic C(O)—C₆H₄—OCH₃ protons. A number-average molar mass is calculated by NMR, assuming 100% functionalization. The function content in polymer EBR1F is calculated by dividing the molar mass determined by size exclusion chromatography by that calculated by NMR. Thus, in EBR1F, 49% of the polymer chain ends have been functionalized with a ketone.

### Example EBR2

The synthesis of polymer EBR2 is identical to that described in Example EBR1, except that:
the 199 mL of toluene are replaced with 197 ml of toluene,
the 1.0 ml of a 2.0 M solution of butylmagnesium chloride in diethyl ether is replaced with 2.1 mL of a 1.0 M solution of mesitylmagnesium bromide in diethyl ether,
1.25 mL of a 1.6 M solution of n-butyllithium in hexane (2.0 mmol, 10.0 mM) are added before the metallocene is introduced,
the functionalization reaction is performed by adding 10.25 mL of a degassed solution, stored over molecular sieves, of 0.38 M 4-methoxybenzonitrile in toluene (3.9 mmol),
the deactivation reaction is performed after stirring for 1 h at 80° C. by pouring the polymer solution onto methanol with stirring to precipitate the polymer.

3.94 g of polymer EBR2F and 0.17 g of polymer EBR2NF from the sample collected prior to the functionalization reaction are recovered. In EBR2F, 30% of the polymer chain ends have been functionalized with a ketone.

### Example EBR3

The synthesis of polymer EBR3 is identical to that described in Example EBR1, except that the 1.0 mL of a 2.0 M solution of butylmagnesium chloride in diethyl ether is replaced with 1.14 mL of a 0.88 M solution of BOMAG in hexane (1.0 mmol, 5 mM in toluene/hexane mixture). 4.04 g of polymer EBR3F and 0.20 g of polymer EBR3NF from the sample collected prior to the functionalization reaction are recovered. In EBR3F, 27% of the polymer chain ends have been functionalized with a ketone.

### Example EBR4

The synthesis of polymer EBR4 is identical to that described in Example EBR1, except that butadiene is purified beforehand by being condensed in a vial in the presence of trioctylaluminium.

3.51 g of polymer EBR4F and 0.19 g of polymer EBR4NF from the sample collected prior to the functionalization reaction are recovered. In EBR4F, 57% of the polymer chain ends have been functionalized with a ketone.

### Example EBR5

The synthesis of polymer EBR5 is identical to that described in Example EBR4, except that the functionalization reaction is performed by the addition of 4-methoxybenzonitrile up to 3 molar equivalents of nitrile function/carbon-Mg bond.

3.4 g of polymer EBR5F and 0.17 g of polymer EBR5NF from the sample collected prior to the functionalization reaction are recovered. In EBR5F, 62% of the polymer chain ends have been functionalized with a ketone.

### Example EBR6

The synthesis of polymer EBR6 is identical to that described in Example EBR1, except that:
the 199 mL of toluene are replaced with 280 ml of methylcyclohexane collected from a solvent fountain (SPS800 MBraun),
the 1.0 mL of a 2.0 M solution of butylmagnesium chloride in diethyl ether is replaced with 0.125 ml of a 2.0 M solution of butylmagnesium chloride in diethyl ether,
the 32 mg of metallocene are replaced with 40.0 mg (62.5 μmol as neodymium) of {(Me₂Si(C₁₃H₈)₂)Nd(μ-BH₄)[(μ-BH₄)Li(THF)]}₂,
the 250 mL reactor is replaced with a 500 mL reactor,
there is no sampling prior to the functionalization reaction,
the functionalization reaction is performed by adding 10 ml of a degassed 0.025 M solution, stored over molecular sieves, of 4-methoxybenzonitrile in methylcyclohexane (0.25 mmol, 1 molar equivalent of nitrile function/carbon-Mg bond),
   13.97 g of polymer EBR6F are recovered. 36% of the polymer chain ends have been functionalized with a ketone.

### Example EBR7

The synthesis of polymer EBR7 is identical to that described in Example EBR6, except that at the end of polymerization, the functionalization reaction is performed by adding 10 mL of a degassed 0.025 M solution, stored over molecular sieves, of 4-dimethylaminobenzonitrile in methylcyclohexane (0.25 mmol, 1 molar equivalent of nitrile function/carbon-Mg bond). 12.14 g of polymer EBR7F are recovered. 42% of the polymer chain ends have been functionalized with a ketone.

The conditions for the copolymerization of ethylene and 1,3-butadiene are given in Table 3. Table 3 also shows for each example the mean catalytic activity expressed in kg·mol⁻¹·h⁻¹. The characteristics of the synthesized copolymers are shown in Tables 4 and 5. The SEC-THF method was used to determine the molar masses of polymers EBR1 to EBR7. The microstructure of the polymers was determined by NMR. The ethylene unit content, the content of 1,3-butadiene unit in the 1,2-configuration (1,2-unit), in the 1,4-configuration (1,4-unit) and the content of 1,2-cyclohexane unit (ring unit) are expressed as molar percentages relative to the total monomer units of the polymer. The copolymers synthesized are statistical.

TABLE 1

| | | | | | Activity |
|---|---|---|---|---|---|
| | | Mg/Nd | Co-solvent | Time | (kg · mol⁻¹ · |
| Polymer | Co-catalyst | ratio | (Et₂O/Mg) | (min) | h⁻¹) |
| PE1 | C₄H₉MgCl | 320 | 4.8 | 21 | 1120 |
| PE2 | C₅H₁₁MgBr | 320 | 4.8 | 142 | 130 |
| PE3 | C₅H₁₁MgBr | 320 | 4.8 | 115 | 110 |
| PE4 | C₅H₁₁MgBr | 320 | 4.8 | 183 | 130 |
| PE5 | C₅H₁₁MgBr | 320 | 4.8 | 144 | 130 |
| PE6 | BrMgC₅H₁₁MgBr | 160 | 0 | 50 | 260 |
| PE7 | C₄H₉MgCl | 320 | 9.6 | 15 | 1540 |
| PE8 | C₅H₁₁MgBr | 320 | 9.6 | 82 | 260 |
| PE9 | C₄H₉MgMes | 320 | 9.6 | 16 | 1560 |
| PE10 | BOMAG | 160 | 19.2 | 26 | 870 |
| PE11 | BOMAG | 160 | 0 | 86 | 190 |
| PE12 | C₄H₉MgCl | 320 | 4.8 | 17 | 1190 |
| PE13 | BOMAG | 160 | 0 | 96 | 170 |

TABLE 2

| | | Functional group | Side |
|---|---|---|---|
| Polymer | Chain end | content (%) (*) | product |
| PE1F | CH₂—C(O)—C₆H₅ | 93 | No |
| PE2F | | 89 | No |
| PE3F | | 93 | No |
| PE4F | | 88 | No |
| PE5F | | 86 | No |
| PE6F | | 78 | No |
| PE7F | CH₂—C(O)—C₆H₄—OMe | 89 | No |
| PE8F | | 82 | No |
| PE9F | | 52 | Yes |
| PE10F | | 46 | Yes |
| PE11F | | 49 | Yes |
| PE12F | CH₂—C(O)—C₄H₉ | 98 | No |
| PE13F | | 43 | Yes |

(*) Measured by 1H NMR

TABLE 3

| | | Mg/Nd | Co-solvent | Time | Activity |
|---|---|---|---|---|---|
| Polymer | Co-catalyst | ratio | (Et₂O/Mg) | (min) | (kg · mol⁻¹ · h⁻¹) |
| EBR1 | C₄H₉MgCl | 40 | 4.8 | 35 | 140 |
| EBR2 | C₄H₉MgMes | 42 | 9.6 | 35 | 140 |
| EBR3 | BOMAG | 20 | 0 | 34 | 140 |
| EBR4 | C₄H₉MgCl | 40 | 4.8 | 40 | 140 |
| EBR5 | C₄H₉MgCl | 40 | 4.8 | 34 | 140 |
| EBR6 | C₄H₉MgCl | 4 | 4.8 | 110 | 120 |
| EBR7 | C₄H₉MgCl | 4 | 4.8 | 120 | 120 |

TABLE 4

| | | | | | Functional |
|---|---|---|---|---|---|
| | Functionalization | Mₙ^{NMR} | Mₙ^{SEC} | | group content |
| Polymer | agent | (g · mol⁻¹) | (g · mol⁻¹) | Ð | (%) |
| EBR1NF | | — | 2000 | 1.3 | — |
| EBR1F | CN—(C₆H₄)—OMe | 4500 | 2200 | 1.4 | 49 |
| EBR2NF | | — | 2100 | 1.3 | — |
| EBR2F | CN—(C₆H₄)—OMe | 5900 | 1800 | 1.5 | 30 |
| EBR3NF | | — | 2300 | 1.6 | — |
| EBR3F | CN—(C₆H₄)—OMe | 8500 | 2300 | 1.6 | 27 |
| EBR4NF | | — | 2900 | 1.4 | — |
| EBR4F | CN—(C₆H₄)—OMe | 5100 | 2900 | 1.4 | 57 |
| EBR5NF | | — | 2200 | 1.3 | — |
| EBR5F | CN—(C₆H₄)—OMe | 3900 | 2400 | 1.4 | 62 |
| EBR6F | CN—(C₆H₄)—OMe | 235 000 | 83 600 | 1.5 | 36 |
| EBR7F | CN—(C₆H₄)—NMe₂ | 142 000 | 59 000 | 1.3 | 42 |

TABLE 5

| Polymer | Ethylene unit | 1,2-Unit | 1,4-Unit | Ring unit |
|---|---|---|---|---|
| EBR1NF | 73.3 | 9.5 | 6.4 | 10.8 |
| EBR1F | 72.9 | 9.7 | 6.5 | 10.9 |
| EBR2NF | 73.4 | 9.8 | 6.6 | 10.2 |
| EBR2F | 72.5 | 10.0 | 6.8 | 10.6 |
| EBR3NF | 73.2 | 10.0 | 6.8 | 10.0 |
| EBR3F | 72.0 | 10.3 | 7.2 | 10.5 |
| EBR4NF | 74.8 | 9.3 | 6.2 | 9.8 |
| EBR4F | 72.4 | 9.6 | 6.5 | 11.5 |
| EBR5NF | 74.1 | 9.2 | 6.2 | 10.5 |
| EBR5F | 74.0 | 9.5 | 6.3 | 10.2 |
| EBR6F | 81.1 | 3.0 | 4.1 | 11.8 |
| EBR7F | 79.6 | 3.6 | 4.6 | 12.2 |

Whether the polymers are polyethylenes or diene copolymers that are rich in ethylene, it is observed that the process in accordance with the invention does indeed lead to the synthesis of ethylene-rich polymers bearing a ketone function at the chain end.

It is also noted that the use of an organomagnesium halide, such as butylmagnesium chloride and pentylmagnesium bromide, as a co-catalyst, allows the highest contents of chain-end ketone function to be obtained. In the case of the synthesis of functional polyethylenes, it is also noteworthy that the functionalization reaction is selective, since no side products are formed.

It is also appreciable that the process allows the simultaneous introduction into the polymer of a ketone function and a second function other than a ketone function, both located at the same chain end of the polymer, without having to resort to using an additional functionalizing agent.

What is claimed is:

1. A process for preparing a polymer containing more than 50 mol % of ethylene units and bearing a ketone function at one of its chain ends,
which process comprises the successive steps a), b) and c)
step a) being the polymerization of an ethylene-containing monomer mixture in the presence of a catalytic system based on at least one metallocene of formula (I) and an organomagnesium reagent 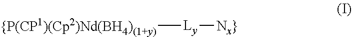
Cp¹ and Cp², which are identical or different, being chosen from the group consisting of fluorenyl groups, cyclopentadienyl groups and indenyl groups, the groups being substituted or unsubstituted,
P being a group bridging the two groups Cp¹ and Cp² and comprising a silicon or carbon atom,
Nd denoting the neodymium atom,
L representing an alkali metal chosen from the group consisting of lithium, sodium and potassium,
N representing a molecule of an ether,
x, which may or may not be an integer, being greater than or equal to 0,
y, which is an integer, being greater than or equal to 0,
step b) being the reaction of a compound containing a nitrile function with the product of the polymerization reaction of step a),
step c) being a hydrolysis reaction,
the polymer being a polyethylene or a copolymer of ethylene and a 1,3-diene and optionally a vinylaromatic compound.

2. The process according to claim 1 in which the monomer mixture is ethylene, a mixture of ethylene and a 1,3-diene or a mixture of ethylene, a 1,3-diene and a vinylaromatic compound.

3. The process according to claim 1, in which the 1,3-diene monomer is 1,3-butadiene, isoprene, myrcene, β-farnesene or mixtures thereof.

4. The process according to claim 1, in which Cp¹ and Cp², which are identical or different, are substituted fluorenyl groups or unsubstituted fluorenyl groups of formula C₁₃H₈.

5. The process according to claim 1, in which the organomagnesium reagent is of formula (IIa), (IIb), (IIc) or (IId) in which R³, R⁴, R⁵ and R^{B}, which are identical or different, represent a carbon-based group, R^{A} represents a divalent carbon-based group, X is a halogen atom, and m is a number greater than or equal to 1,

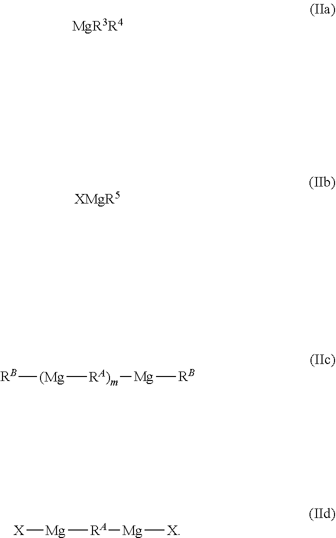

6. The process according to claim 1, in which the organomagnesium reagent is an organomagnesium halide.

7. The process according to claim 1, in which the organomagnesium reagent is an organomagnesium halide of formula XMgR⁵, X being a chlorine or bromine atom, R⁵ being an alkyl or an aryl.

8. The process according to claim 1, in which the compound containing a nitrile function contains a single nitrile function.

9. The process according to claim 1, in which the compound containing a nitrile function is a compound which contains a second function which is chosen from ether, thioether, protected amine, tertiary amine, alkoxysilane and imidazole functions.

10. The process according to claim 1, in which the compound containing a nitrile function is an alkane substituted with a nitrile function and with a function which is chosen from ether, thioether, protected amine, tertiary amine and alkoxysilane functions.

11. The process according to claim 1, in which the compound containing a nitrile function is an arene substituted with a nitrile function.

12. The process according to claim 1, in which the compound containing a nitrile function is a benzonitrile substituted with a function chosen from ether, thioether, protected amine, tertiary amine and imidazole functions.

13. A polymer containing more than 50 mol % of ethylene units and bearing at one of its chain ends a ketone function and optionally a second function which is borne on the same chain end as the ketone function and which is chosen from ether, thioether, amine, alkoxysilane, silanol and imidazole functions, which polymer is a copolymer of ethylene and a 1,3-diene or a copolymer of ethylene, a 1,3-diene and a vinylaromatic compound.

14. A polyethylene bearing at one of its chain ends a ketone function and a second function which is borne on the same chain end as the ketone function and which is chosen from ether, thioether, amine, alkoxysilane, silanol and imidazole functions.

15. The process according to claim 2 in which the vinylaromatic compound is styrene.

16. The process according to claim 4, in which the Cp¹ and Cp² are unsubstituted fluorenyl groups.

17. The process according to claim 5, in which the m is equal to 1.

18. The process according to claim 6, in which the organomagnesium halide is of formula (IIb) or (IId):

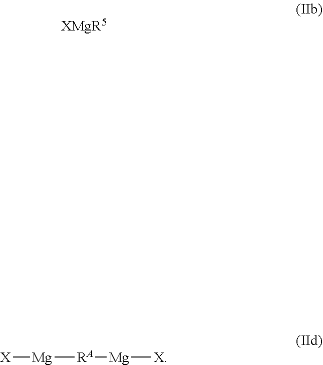

19. The process according to claim 9, in which the second function is an ether function, a tertiary amine function, an alkoxysilane function or an imidazole function.

20. The process according to claim 10, in which the function which is chosen from ether, thioether, protected amine, tertiary amine and alkoxysilane functions is a tertiary amine function or an alkoxysilane function.

21. The process according to claim 11, in which the nitrile function is a substituted benzonitrile.

22. The process according to claim 12, in which the function chosen from ether, thioether, protected amine, tertiary amine and imidazole functions.
